(19) United States
(12) Patent Application Publication
(10) Pub. No.: US 2015/0313397 A1
(43) Pub. Date: Nov. 5, 2015

(54) Extraction Tool for Stemming Soft Fruit and Berries

(71) Applicant: Sun Y. Kim, Hayward, CA (US)

(72) Inventor: Sun Y. Kim, Hayward, CA (US)

(21) Appl. No.: 14/267,044

(22) Filed: May 1, 2014

(51) Int. Cl. A47J 25/00

(52) U.S. Cl. CPC A47J 25/00

(57) ABSTRACT

A finger operated extraction tool for stemming strawberries and other fruit and produce, the tool having a U-shaped configuration with two elongated prongs with pointed tips having a flat band end interconnecting the two prongs and spacing the prongs apart, the band end forming a leaf spring that returns the prongs to a parallel position after the tips of the prongs are urged together by a user's fingers, the prongs preferably being bifurcated forming two tines with pointed end and having edges that are sharpened for improved stemming.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF INVENTION

This invention relates to an extraction tool and in a preferred embodiment to a manual stemming tool for soft fruit and berries that are easily damaged by typical coring tools.

### BACKGROUND OF THE INVENTION

The manual extraction tool of this invention is designed as a simple, inexpensive hand tool particularly adapted to extract the stem from soft fruit and berries. Typically problematic is the removal of the stem and part of the core of the strawberry. The process, also called hulling, can be performed using a common paring knife. The knife can be employed to cut across the top of the strawberry removing the stem, cap and part of the core. However, this simple procedure sacrifices part of the fruit. The chef's technique of holding the paring knife at an angle while turning the fruit, saves more of the fruit, but can damage the remaining strawberry, particularly if ripe.

The prior invention of Holcomb et al, U.S. Pat. No. 8,234,975, issued Aug. 7, 2012, entitled “Hulling Device,” discloses a mechanically actuated hand tool specifically designed for hulling strawberries. The device is constructed to be operated with one hand while holding the strawberry in the other hand. The hulling device has a thumb-operated push cap at the end of a housing having a pair of oppositely-projecting finger rests allowing two of the user's adjacent fingers (typically the index finger and middle finger) to hold the device. The push cap displaces a spring-loaded pushing member that articulates nipping members that project from the opposite end of the device opposite. The four preferred nipping members form a substantially conical end that splays when the cap is pushed. This allows the separated tips of the nipping members to be inserted into the fruit around the stem. The device is twisted and pulled as the cap is retracted by the spring to grasp and remove the stem, stem cap and part of the core of the strawberry.

The hulling device of Holcomb et al, is a clever articulated mechanical device that is more complex than needs be for the primary task at hand, the stemming of strawberries. The complexity of the assembly with its many moving parts though fun to use, makes the hulling device difficult to thoroughly clean. Additionally, the device of Holcomb et al has little use other than a specialty tool for hulling strawberries. The configuration and orientation of the nipping members and the articulated extraction operation under spring force render the Holcomb et al device less suitable for harder fruit and berries. In this respect, the extraction device of this invention when employed as a hulling or coring device has the advantage that it can operate on harder fruit, berries or vegetables.

### SUMMARY OF THE INVENTION

The manual extraction tool in a preferred embodiment of a stemming tool is a simplified hand tool that is inexpensive to make, compact, and easy to use and clean. The stemming tool is preferably made with only one or two separate parts that are configured for intuitive finger operation. The stemming tool is generally structured as single-piece tongs. Two opposed and pointed prongs converge when the prongs are urged together by the user's fingers in the manner of operating a tweezer.

The U-shaped configuration of the single-piece tongs simplifies fabrication and is structurally advantageous, since the hardening characteristic that provides the spring to the U-shape is advantageous for sharpening the edges of the pointed prongs to facilitate coring. The structure has multiple uses, but for use as a stemming tool, the prongs are curved and bifurcated into two tines with at least the outer edges sharpened to improve cutting. The tines follow the contour of the prong point and provide both a cutting function and a grasping function when the stemming tool is inserted into a fruit top, twisted to core a selected section, pinched and withdrawn to extract the stem, berry cap and partial core of the strawberry. The relatively simple structure and design coupled with the curved prongs that provide rigidity enable the coring tool to operate on firm as well as soft fruit and vegetables.

In the preferred embodiment, the connected ends of the unitary prongs encircle a plug. The plug assists in initially positioning the pointed ends of the prongs apart and is configured as a cylindrical member with an axis preferably oriented transverse to the generally longitudinal axis of the prongs. In an alternate embodiment the plug forms a casing for a battery and includes a switch and a light emitting diode to provide a light source to facilitate extraction of the target object.

### BRIEF DESCRIPTION OF THE DRAWINGS:

FIG. 1 is a side view of a first embodiment of the manual extraction tool of this invention.

FIG. 2 is a top view of the manual extraction tool of FIG. 1.

FIG. 3 is an end view of the manual extraction tool of FIG. 1.

FIG. 4 is a side view of a second embodiment of the manual extraction tool of this invention.

FIG. 5 is a top view of the manual extraction tool of FIG. 4.

FIG. 6 is a perspective view of the manual extraction tool of FIG. 4.

FIG. 7 is a side view of a third embodiment of the manual extraction tool of this invention.

FIG. 8 is a top view of the manual extraction tool of FIG. 7.

### DETAILED DESCRIPTION OF THE PREFERRED EMBODIMENTS:

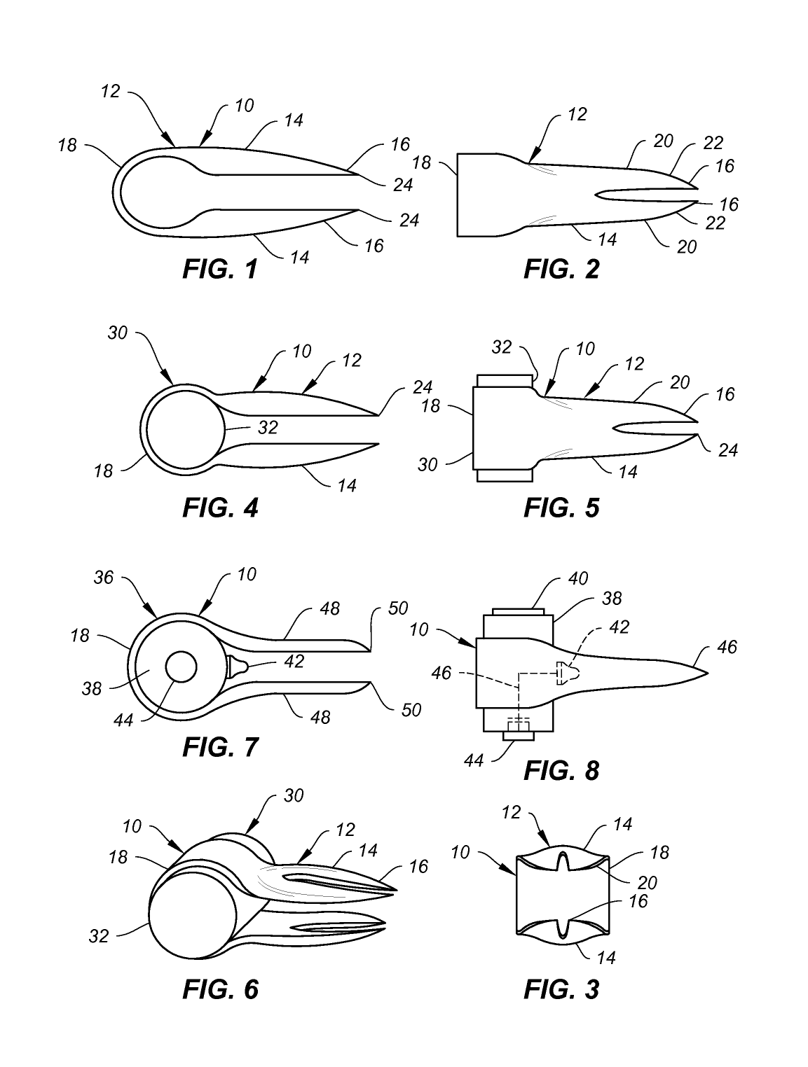

Referring to FIGS. 1 and 2 the manual extraction tool, designated generally by the reference numeral 10, is fashioned as a basic fruit and beery stemming tool 12. The basic stemming tool is fabricated in a one-piece construction from a relatively rigid material with spring-like characteristics, such as spring steel or hard resilient plastic. The stemming tool 12 has the general form of small, one-piece tongs, with two elongated, opposed prongs 14 with an overall length a little more than two inches. For larger fruit such as persimmons or tomatoes, the size can be correspondingly bigger, if used as a dedicated tool for one particular type of produce.

The opposed prongs taper from an interconnected flat band end 18 to a generally pointed tip end 16. The wider interconnected band end 18 has a circular curvature formed in a U-shaped configuration to space the prongs 14 apart in a substantially parallel arrangement. The circular curvature of the band end 18 is at least 180 degrees and provides a leaf spring action to return the prongs 14 to the parallel position shown in the drawings after the tip ends 16 of the prongs 14 have been urged together by the user's thumb and index finger when extracting a fruit or berry stem.

The opposed prongs 14 are partly bifurcated in the preferred configuration, forming two tines 20. The prongs 14 have sharpened outer edges 22 and have an arcuate cross-section, somewhat less than 180 degrees, as illustrated in the end view of FIG. 3. In addition to following the curvature of a fruit stem or cap, the curvature provides rigidity to the elongated prongs. Each of the two tines 20 at the tip ends 16 of the two prongs 14 have a sharpened end point 24 for piercing the fruit or berry around the stem before rotating the stemming tool 12, or the pierced fruit or berry, a partial turn to core the fruit or berry around the stem. The prongs 14 are urged together by the user's fingers while simultaneously extracting the stem.

Manipulating the extraction tool 10 can be improved as shown by an alternate embodiment of the stemming tool 30 of FIGS. 4-6 by the insertion of a short cylindrical barrel 32 between the opposed prongs 14 at the interconnecting band end 18. The cylindrical barrel 32 located in the circular curvature at the interconnect band end 18 extends a short distance beyond the width of the band end 18 to assist in gripping and holding the extraction tool 10. In addition, the cylindrical barrel 32 provides leverage when the fingers urge the prongs 14 together and incidentally inhibits the curved portion from collapsing or breaking from fatigue. The cylindrical barrel 32 is preferably made from a slightly deformable material such as cork, plastic or rubber. The cylindrical barrel 32 can be withdrawn and used as a tine point cushion to prevent inadvertent injury when the stemming tool 12 is stored. In other respects, the stemming tool 30 with the added barrel 32 is the same as the stemming tool 32 of FIGS. 1 and 2.

Referring now to FIGS. 7 and 8, the extraction tool 10 is modified in a further alternate embodiment as an illuminated plucking tool 36. A first feature substitutes a cylindrical battery casing 38 with a battery 40 and a small lamp 42 such as an LED for the cylindrical barrel 32. At one end of the cylindrical casing 38 is a small button switch 44. The button switch 44 is connected to the lamp 42 by an electronic circuit 46 within the casing 38, shown in dotted line in FIG. 8.

The prior embodiment having the transverse barrel 32 can include this added feature if desired. The plucking tool 36 of FIGS. 7 and 8 has different prongs 48. The prongs 48 of the plucking tool 36 retain the cross-section curvature, but omit the bifurcation and dual tines of the prior embodiments. This expands the use of the extraction tool 10 to not only the extraction of stems, but splinters and the like. By fashioning the plucking tool with slightly rounded and flattened end tips 46, the extraction tool 10 of this embodiment can be used to extract splinters, nose hairs or even a foxtail from the nose of a pet when the end of the seed is still visible. This compact extraction tool in all embodiments has a variety of medical uses and can be a welcome addition to any first aid kit.

It is to be understood that other modifications can be made without departing from the spirit of the invention as will be defined by the claims.

1. A finger operated extraction tool comprising:
two elongated prongs having a flat interconnected band end and opposed pointed tip ends, the two prongs tapering from the flat interconnected band end to the pointed tip ends, wherein the band end has a U-shaped configuration that spaces the prongs apart in a substantially parallel arrangement, the U-shaped band end forming a leaf spring that returns the prongs to the spaced parallel position after a human user has urged the pointed ends of the prongs together by the user's thumb and index fingers, wherein each prong has an arcuate cross section between the flat interconnected band end and the pointed tip ends to provide rigidity to the prongs.

2. The finger operated extraction tool of claim 1 wherein the two prongs are partly bifurcated at the tip ends of the prongs wherein two tines that are sharply pointed are formed.

3. The finger operated extraction tool of claim 2 wherein the prongs have outer edges that are sharpened.

4. The finger operated extraction tool of claim 1 wherein the U-shaped band end has a cylindrical barrel around which the U-shaped band end is wrapped.

5. The finger operated extraction tool of claim 4 wherein the U-shaped band end has a width and the barrel has a length with the length of the barrel being marginally greater than the width of the band end.

6. The finger operated extraction tool of claim 4 wherein the cylindrical barrel includes a battery, a lamp and a lamp switch that activates the lamp.

7. The finger operated extraction tool of claim 1 wherein the two prongs are partly bifurcated at the tip ends of the prongs wherein two tines that are sharply pointed are formed, and wherein the prongs have outer edges that are sharpened.

8. The finger operated extraction tool of claim 7 wherein the U-shaped band end has a cylindrical barrel around which the U-shaped band end is wrapped.

9. The finger operated extraction tool of claim 8 wherein the U-shaped band end has a width and the barrel has a length with the length of the barrel being marginally greater than the width of the band end.

10. The finger operated extraction tool of claim 8 wherein the cylindrical barrel is removable.
